(19) United States
(12) Patent Application Publication
(10) Pub. No.: US 2016/0169175 A1
(43) Pub. Date: Jun. 16, 2016

(54) ARRANGEMENT OF A VALVE CLIPPED TO A PUMP

(71) Applicant: DELPHI INTERNATIONAL OPERATIONS LUXEMBOURG S.A R.L., Bascharage (LU)

(72) Inventors: Richard Dupont, Tours (FR); Jean-Luc Rouet, Chitenay (FR)

(73) Assignee: DELPHI INTERNATIONAL OPERATIONS LUXEMBOURG S.A R.L., Bascharage (LU)

(21) Appl. No.: 14/907,968

(22) PCT Filed: Jul. 10, 2014
(86) PCT No.: PCT/EP2014/064828

§ 371 Date: Jan. 27, 2016

(30) Foreign Application Priority Data
Jul. 31, 2013 (FR) 1357558

(51) Int. Cl. F02M 59/48; F02M 63/02; F16K 27/02; F02M 59/46

(52) U.S. Cl. CPC F02M 59/48; F02M 59/46; F02M 63/0225; F16K 27/029

(57) ABSTRACT

A snap-fitted arrangement of a valve on a pump includes means of which at least one is elastic such that one of the means is integrated with the valve and the other means is integrated with the pump. The means are arranged in a complementary manner in a linear engagement of the male-female type such that the elastic means elastically deforms during engagement. One of the means includes a channel and the other means includes a protuberance which engages the channel.

### CROSS REFERENCE TO RELATED APPLICATIONS

This application is a national stage application under 35 USC 371 of PCT Application No. PCT/EP2014/064828 having an international filing date of Jul. 10, 2014, which is designated in the United States and which claimed the benefit of French Patent Application No. 1357558 filed on Jul. 31, 2013, the entire disclosures each are hereby incorporated by reference in their entirety.

### TECHNICAL FIELD

The present invention relates to the snap-fitted arrangement of a valve on a pump body or at the end of a common rail supplying injectors.

### TECHNOLOGICAL BACKGROUND TO THE INVENTION

A valve is generally arranged and attached on a high-pressure pump body by means of screws. The valve is first centered on the body by fitting a female cylindrical surface of the valve onto a male cylindrical surface of the pump body, then securing the assembly by means of screws. Furthermore, the arrangement of a high-pressure valve at the end of the common rail of an injection system also comprises a centering means then an attachment. In this case the valve body may be threaded so as to be directly screwed onto the end of the rail, which is itself threaded.

Whatever the type of valve and the device on which it is placed, the arrangement requires attachment means, specific machining and assembly time.

### SUMMARY OF THE INVENTION

The present invention aims to solve these problems by proposing an arrangement of a valve on a device, the casing of the valve being snap-fitted onto the body of the device.

More particularly, the casing and the body have, integrated therein, means of which at least one is elastic, said means being arranged in a complementary manner in a linear engagement along a main axis. The engagement is of the male-female type and is a force fit. During the engagement, the elastic means deforms.

One of the means comprises a channel and the other means comprises a protuberance arranged so as to engage in the channel at the end of the force-fitting such that the valve casing is snap-fitted onto the body of the device.

The casing and the body are provided with radial faces arranged pressing against one another when the protuberance engages in the channel such that the casing is snap-fitted onto the body and is axially positioned relative to the body.

During the engagement of the protuberance in the channel, the elastic means returns to its rest shape retaining a residual elastic deformation such that the casing is snap-fitted, positioned axially A and held radially relative to the body.

The channel and the protuberance are provided with complementary faces held against one another by the residual elastic deformation. This produces an axial force pressing the casing against the body such that the valve is snap-fitted, axially and held radially relative to the device.

The complementary means comprise two cylindrical, tubular portions of which at least one is crenellated such that the merlons are elastically deformable.

The protuberance is an annular bead integrated into the internal face of the female tubular portion and in which the channel is an annular channel integrated into the external face of the male tubular portion.

The complementary faces of the channel and of the bead are conical faces whose vertices are on the main axis and are oriented towards the interior of the body.

Furthermore, once assembled, the valve and the device may be separated in a non-destructive manner. The elastic portion deforms as before.

More particularly, the body is that of a high-pressure fuel pump and the valve, arranged by snap-fitting on the pump body, controls the ingress of fuel into the pump.

The invention also relates to a valve able to be arranged in an arrangement created according to the preceding paragraphs.

### BRIEF DESCRIPTION OF THE DRAWINGS

Other features, aims and advantages of the invention will emerge upon reading the following detailed description, and with reference to the appended drawings, which are provided by way of non-limiting example and in which:

FIG. 1 is an axial section through a valve casing arranged on a high-pressure pump.

FIG. 2 is a detail of FIG. 1.

FIG. 3 is an external view of the valve casing of FIG. 1.

FIG. 4 is an axial section through a valve arranged at the end of the common rail of a system on a high-pressure pump.

### DESCRIPTION OF THE PREFERRED EMBODIMENTS

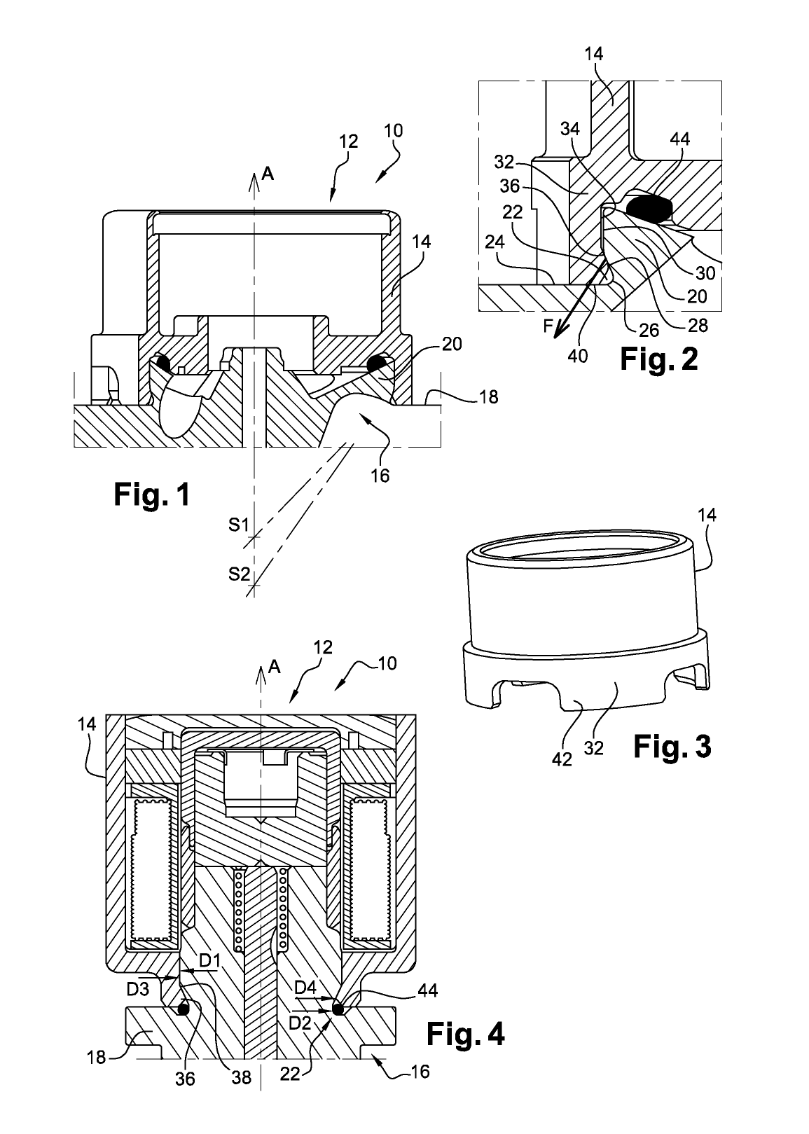

A first non-limiting embodiment of the arrangement 10 according to the invention is now described with reference to FIGS. 1, 2 and 3.

A valve 12, of which only the casing 14 is shown, is arranged at the head of a high-pressure pump 16.

The body 18 of the pump 16 is provided with an open bore extending along a main axis A and surrounded at its opening by a cylindrical projection 20 having a first diameter D1 (called out in FIG. 4). At the base of the projection 20, there is created an annular channel 22 and, on the periphery of the projection 20, the body 18 is provided with a radial disk surface 24 connecting to the projection 20 along a peripheral fillet 26 forming the bottom of the channel 22. The bottom of the channel has a second diameter D2 (called out in FIG. 4). The fillet 26 connects upwards, in the conventional and non-limiting sense of the figures, with a widening conical surface 28 whose vertex S1 is on the main axis A inside the pump body 16. The conical surface 28 returns, at the top, to the first diameter D1 of the main cylindrical surface 30 of the projection 20. In one preferred embodiment, the angle at the vertex of the cone is between 10° and 45°.

The casing 14 of the valve 12 is provided with a generally cylindrical peripheral base 32 which, in the arrangement 10, is coaxial A with the projection 20. The base 32 has a cylindrical internal surface 34 having a third diameter D3 (called out in FIG. 4), barely larger than the first diameter D1, and which terminates at its lower end, in the conventional and non-limiting sense of the figures, in a peripheral internal bead 36 forming a radial protuberance. The bead 36 connects to the cylindrical surface 34 along a short conical surface 38, whose vertex S2 is on the main axis A close to the vertex S1 of the conical surface 28 of the projection 20, the angle at the vertex of the conical surface 38 being slightly less than the angle at the vertex of the cone of the channel 22. The conical surface 38 of the casing 14 extends towards the end of the base 32 as far as a fourth diameter D4 (called out in FIG. 4), slightly larger than that, D2, of the bottom of the channel 22, then it widens rapidly, connecting downwards to a radial disk surface 40.

Furthermore, and more particularly visible in FIG. 3, the base 32 of the casing 14 is crenellated such that the merlons 42 thus created are provided with a slight radial elasticity. The peripheral bead 36, for its part, is only on the merlons 42.

The arrangement 10 of the valve 12 on the pump body 18 is now described.

Before the assembly is effected, the valve 12 and the pump 18 are aligned along the main axis A and brought together such that the bead 36 is in contact with the vertex of the projection 20. By exerting, on the casing 14 of the valve, an axial force oriented towards the pump, the merlons 42 open slightly in an elastic manner such that the projection 20 enters into the base 32 of the valve, the vertex of the bead 36, of diameter D4, engaging around the cylindrical surface 30 and sliding until the bead 36 is arranged in the channel 22. The elastically deformed merlons 42 return to a shape close to the rest shape but retain a residual elastic deformation. The two conical surfaces 28, 38, are then pressed against one another by the residual deformation, which produces, on each merlon 42, a force F normal to the conical surfaces 28, 38 in contact, the resulting force of all the forces F being along the main axis A and oriented towards the pump 16. The casing 14 of the valve, on which this resulting axial force acts, is then pressed against the pump body, the two disk surfaces 24, 40 being in contact against one another.

The leaktightness of the arrangement 10 is ensured by an O-ring 44 arranged between the casing 14 and the pump body 18, the seal 44 having been placed prior to the engagement of the valve base 32 about the projection 20.

It therefore appears that the arrangement 10 thus created positions the valve 12 relative to the body 18 both in the direction of the main axis A, the valve 12 being forced to press against the pump body 18, and in the radial direction, the tight fit of the diameters preventing this type of movement.

The residual deformation of the merlons 42 holds in position but the forces produced may be overcome and the valve 12 may be repositioned angularly by turning it about the main axis A.

Similarly, the valve 12 may be removed by exerting, on the casing 14, an “upward” axial force such that the merlons 42 again open elastically and once more slide along the projection 20.

Many alternatives may be created according to the above-described teachings. Thus, the projection may be crenellated such that the merlons thus formed deform radially towards the main axis. In addition, the engagement with the female valve and the male pump may be reversed, the valve base entering the body, the merlons opening whether they are on the valve or on the projection.

A second embodiment is now described briefly with reference to FIG. 4. It relates to a valve 12 arranged at the end of the common rail 16 of an injection system. The principle is similar to that of the first embodiment, the crenellated base of the valve being provided with a bead which is received in a groove created at the base of a cylindrical portion extending from the common rail. The main difference resides in the position of the O-ring seal which in this case is arranged at the bottom of the channel and on which the end of the bead presses.

As shown in the figures, the casing 14 encloses an electromagnetic actuator comprising a fixed winding and an axially mobile core cooperating with a valve. In this context, the casing 14 of the valve 12 is made of magnetic steel and the described snap-fitted arrangement provides excellent direct contact between the steel of the casing 14 and that of the pump body or that of the common rail, providing magnetic continuity favorable to the operation of the whole.

1. (canceled)

2. The arrangement as claimed in claim 9, in which the casing and the body are provided with radial faces arranged pressing against one another when the protuberance engages in the channel such that the casing is snap-fitted onto the body and is axially positioned relative to the body.

3. The arrangement as claimed in claim 2, in which, when the protuberance engages in the channel, the elastic means returns to its rest shape, retaining a residual elastic deformation such that the casing is snap-fitted, positioned axially and held radially relative to the body.

4. The arrangement as claimed in claim 3, in which the channel and the protuberance are provided with complementary faces held against one another by the residual elastic deformation and producing an axial force pressing the casing against the body such that the valve is snap-fitted, axially and held radially relative to the device.

5. The arrangement as claimed in claim 4, in which the complementary faces of the channel and of the protuberance are conical faces whose vertices are on the main axis and are oriented towards the interior of the body.

6. The arrangement as claimed in claim 9, in which the elastic means deforms, thereby allowing the valve and the device to be separated in a non-destructive manner.

7. The arrangement as claimed in claim 9, in which the body is that of a high-pressure fuel pump and in which the valve controls the ingress of fuel into the pump.

8. (canceled)

9. An arrangement of a valve on a device, a casing of the valve being snap-fitted onto a body of the device, the arrangement comprising:
means of which at least one is elastic, said means being integrated therein with the casing and the body, said means being arranged in a complementary manner in a linear engagement along a main axis, the engagement being of the male-female type and being a force fit, in the course of which the elastic means deforms and in which one of the means comprises a channel and the other means comprises a protuberance arranged so as to engage in the channel at the end of the force-fitting such that the casing of the valve is snap-fitted onto the body of the device and in which,
the means comprise two tubular cylindrical portions of which at least one is crenellated such that its merlons are elastically deformable and in which,
the protuberance is an annular bead integrated into an internal face of one of the tubular cylindrical portions and in which the channel is an annular channel integrated into an external face of the other of the tubular cylindrical portions.
